(19) United States
(12) Patent Application Publication
(10) Pub. No.: US 2016/0029022 A1
(43) Pub. Date: Jan. 28, 2016

(54) VIDEO PROCESSING APPARATUS WITH ADAPTIVE CODING UNIT SPLITTING/MERGING AND RELATED VIDEO PROCESSING METHOD

(71) Applicant: MEDIATEK INC., Hsin-Chu (TW)

(72) Inventors: Chia-Yun Cheng, Hsinchu County (TW); Chih-Ming Wang, Hsinchu County (TW); Yung-Chang Chang, New Taipei City (TW); Chun-Chia Chen, Hsinchu City (TW); Meng-Jye Hu, Taoyuan City (TW); Huei-Min Lin, Hsinchu County (TW)

(21) Appl. No.: 14/806,664

(22) Filed: Jul. 23, 2015

Related U.S. Application Data
(60) Provisional application No. 62/028,943, filed on Jul. 25, 2014.

(51) Int. Cl. H04N 19/119; H04N 19/91

(52) U.S. Cl. CPC H04N 19/119; H04N 19/91

(57) ABSTRACT

A video processing apparatus includes a first processing circuit, a second processing circuit, and a control circuit. The first processing circuit performs a first processing operation. The second processing circuit performs a second processing operation different from the first processing operation. The control circuit generates at least one output coding unit to the second processing circuit according to an input coding unit generated from the first processing circuit, wherein the control circuit checks a size of the input coding unit to selectively split the input coding unit into a plurality of output coding units.

### CROSS REFERENCE TO RELATED APPLICATIONS

This application claims the benefit of U.S. provisional application No. 62/028,943, filed on Jul. 25, 2014 and incorporated herein by reference.

### BACKGROUND

The present invention relates to video processing, and more particularly, to a video processing apparatus with adaptive coding unit splitting/merging and a related video processing method.

The conventional video coding standards generally adopt a block based coding technique to exploit spatial and temporal redundancy. For example, the basic approach is to divide the whole source picture into a plurality of blocks, perform intra/inter prediction on each block, transform residues of each block, and perform quantization and entropy encoding. Besides, a reconstructed picture is generated in a coding loop to provide reference pixel data used for coding following blocks. For certain video coding standards, in-loop filter(s) may be used for enhancing the image quality of the reconstructed frame.

The video decoder is used to perform an inverse operation of a video encoding operation performed by a video encoder. For example, the video decoder may have a plurality of processing circuits, such as an entropy decoding circuit, an intra prediction circuit, a motion compensation circuit, an inverse quantization circuit, an inverse transform circuit, and a reconstruction circuit, a deblocking filter. In a conventional design, the video decoder may decode coding units of a picture in a pipeline manner for achieving better decoding efficiency. For example, entropy decoding, motion compensation/intra prediction, reconstruction, and in-loop deblocking may form different pipeline stages. Hence, one coding unit will undergo entropy decoding, motion compensation/intra prediction, reconstruction and in-loop deblocking one by one. When the entropy decoding stage is used to process a first coding unit, the motion compensation/intra prediction stage may be used to process a second coding unit, the reconstruction stage may be used to process a third coding unit, and the in-loop deblocking stage may be used to process a fourth coding unit. However, for certain coding standards, different coding units in the same picture are allowed to have different coding unit sizes. In a case where a current pipeline stage is used to decode a large-sized coding unit and a next pipeline stage is used to decode a small-sized coding unit, the next pipeline stage may finish decoding of the small-sized coding unit before the current pipeline stage finishes decoding of the large-sized coding unit. In another case where a current pipeline stage is used to decode a small-sized coding unit and a next pipeline stage is used to decode a large-sized coding unit, the current pipeline stage may finish decoding of the small-sized coding unit before the next pipeline stage finishes decoding of the small-sized coding unit. As a result, pipeline imbalance occurs under the condition that the coding units to be decoded do not have the same size.

With regard to the pipeline based video decoder design, coding units with various coding unit sizes may cause several drawbacks, such as more waiting cycles, lower decoding throughput, and higher pipeline buffer requirement. Thus, there is a need for an innovative video processing design which is capable of avoiding/mitigating these drawbacks resulting from coding units with various coding unit sizes.

### SUMMARY

One of the objectives of the claimed invention is to provide a video processing apparatus with adaptive coding unit splitting/merging and a related video processing method.

According to a first aspect of the present invention, an exemplary video processing apparatus is disclosed. The exemplary video processing apparatus includes a first processing circuit, a second processing circuit, and a control circuit. The first processing circuit is configured to perform a first processing operation. The second processing circuit is configured to perform a second processing operation different from the first processing operation. The control circuit is configured to generate at least one output coding unit to the second processing circuit according to an input coding unit generated from the first processing circuit, wherein the control circuit checks a size of the input coding unit to selectively split the input coding unit into a plurality of output coding units.

According to a second aspect of the present invention, an exemplary video processing apparatus is disclosed. The exemplary video processing apparatus includes a first processing circuit, a second processing circuit, and a control circuit. The first processing circuit is configured to perform a first processing operation. The second processing circuit is configured to perform a second processing operation different from the first processing operation. The control circuit is configured to generate at least one output coding unit to the second processing circuit according to a plurality of input coding units generated from the first processing circuit, wherein the control circuit checks sizes of the input coding units to selectively merge the input coding units into a single output coding unit.

According to a third aspect of the present invention, an exemplary video processing method is disclosed. The exemplary video processing method includes: performing a first processing operation to generate an input coding unit; generate at least one output coding unit according to the input coding unit generated from the first processing operation, comprising checking a size of the input coding unit to selectively split the input coding unit into a plurality of output coding units; and perform a second processing operation upon the at least one output coding unit, wherein the second processing operation is different from the first processing operation.

According to a fourth aspect of the present invention, an exemplary video processing method is disclosed. The exemplary video processing method includes: performing a first processing operation to generate a plurality of input coding units; generating at least one output coding unit according to the input coding units generated from the first processing operation, comprising checking sizes of the input coding units to selectively merge the input coding units into a single output coding unit; and performing a second processing operation upon the at least one output coding unit, wherein the second processing operation is different from the first processing operation.

According to a fifth aspect of the present invention, an exemplary video processing apparatus is disclosed. The exemplary video processing apparatus includes a plurality of processing circuits and a control circuit. The processing circuits include an entropy decoding circuit, an inverse scan circuit, an inverse quantization circuit, an inverse transform circuit, a reconstruction circuit, an in-loop filter, a reference picture buffer, an intra prediction circuit, and a motion compensation circuit. The control circuit is coupled between a first processing circuit and a second processing circuit of the processing circuits, and is configured to generate at least one output coding unit to the second processing circuit according to at least one input coding unit generated from the first processing circuit, wherein a size of each of the at least one input coding unit is different from a size of each of the at least one output coding unit.

These and other objectives of the present invention will no doubt become obvious to those of ordinary skill in the art after reading the following detailed description of the preferred embodiment that is illustrated in the various figures and drawings.

### BRIEF DESCRIPTION OF THE DRAWINGS

FIG. 1 is a diagram of a video processing apparatus according to an embodiment of the present invention.

FIG. 2 is a diagram illustrating recursive partitioning of one superblock into various sizes of mode information units.

FIG. 3 is a diagram illustrating a control circuit with a coding unit splitting function according to an embodiment of the present invention.

FIG. 4 is a flowchart illustrating a coding unit splitting method according to an embodiment of the present invention.

FIG. 5 is a diagram illustrating a control circuit with a coding unit merging function according to an embodiment of the present invention.

FIG. 6 is a flowchart illustrating a coding unit merging method according to an embodiment of the present invention.

FIG. 7 is a diagram illustrating a control circuit with a FIFO buffering function according to an embodiment of the present invention.

FIG. 8 is a diagram illustrating a picture partitioned into coding units with various coding unit sizes according to an embodiment of the present invention.

FIG. 9 is a diagram illustrating a video processing apparatus having a plurality of pipeline stages and a plurality of control circuits according to an embodiment of the present invention.

FIG. 10 is a diagram illustrating the pipeline processing of coding units according to an embodiment of the present invention.

FIG. 11 is a diagram illustrating a control circuit that supports at least two of the coding unit splitting function, the coding unit merging function and the FIFO buffering function according to an embodiment of the present invention.

### DETAILED DESCRIPTION

Certain terms are used throughout the following description and claims, which refer to particular components. As one skilled in the art will appreciate, electronic equipment manufacturers may refer to a component by different names. This document does not intend to distinguish between components that differ in name but not in function. In the following description and in the claims, the terms “include” and “comprise” are used in an open-ended fashion, and thus should be interpreted to mean “include, but not limited to . . . ”. Also, the term “couple” is intended to mean either an indirect or direct electrical connection. Accordingly, if one device is coupled to another device, that connection may be through a direct electrical connection, or through an indirect electrical connection via other devices and connections.

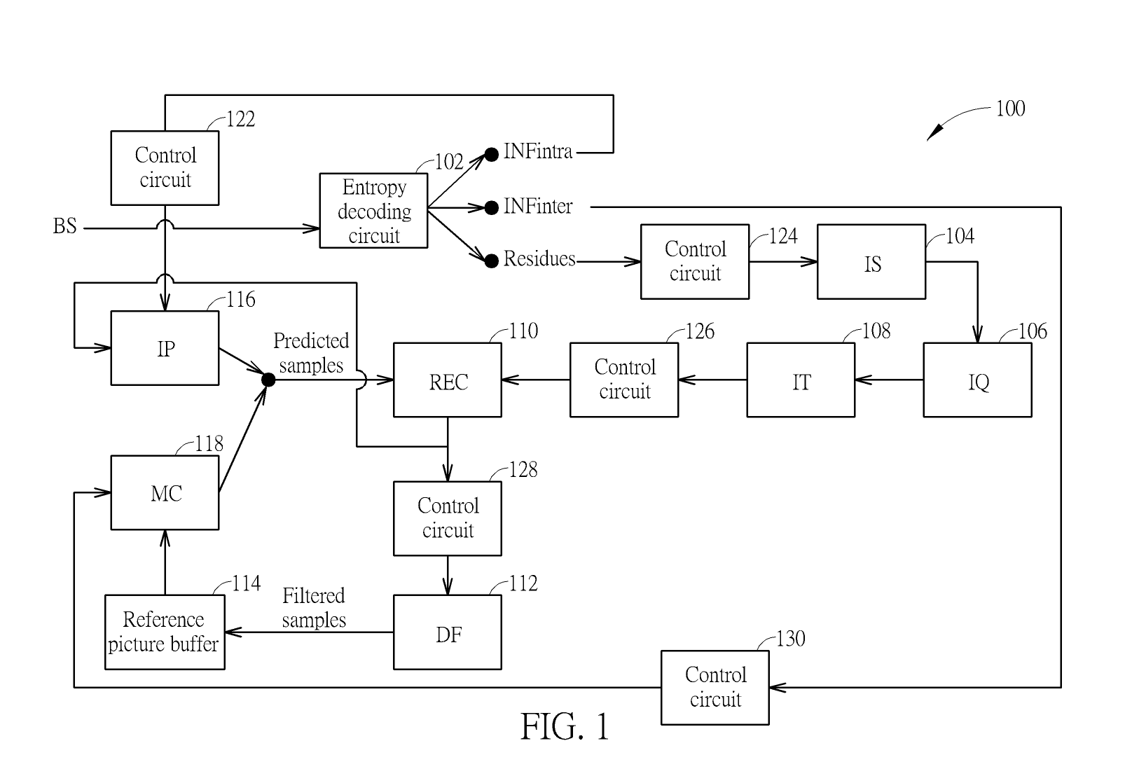

FIG. 1 is a diagram of a video processing apparatus according to an embodiment of the present invention. The video processing apparatus 100 may be part of an electronic device, such as a personal computer (e.g., a laptop computer or a desktop computer), a mobile phone, a tablet, or a wearable device. The video processing apparatus 100 may include at least a portion (i.e., part or all) of a video decoder for decoding a bitstream BS to generate a video sequence composed of a plurality of consecutive decoded pictures (i.e., reconstructed pictures). At least a portion of the video processing apparatus 100 may be implemented in an integrated circuit (IC). To put it simply, any electronic device or electronic system using the proposed video processing apparatus 100 falls within the scope of the present invention.

As shown in FIG. 1, the video processing apparatus (e.g., video decoder) 100 includes a plurality of processing circuits, such as an entropy decoding circuit 102, an inverse scan circuit (denoted as “IS”) 104, an inverse quantization circuit (denoted as “IQ”) 106, an inverse transform circuit (denoted as “IT”) 108, a reconstruction circuit (denoted as “REC”) 110, at least one in-loop filter (e.g., a deblocking filter (DF) 112), a reference picture buffer 114, an intra prediction circuit (denoted as “IP”) 116, and a motion compensation circuit (denoted as “MC”) 118. The reference picture buffer 114 may be an external storage device such as an off-chip dynamic random access memory (DRAM). By way of example, but not limitation, the video processing apparatus 100 may be used to decode the incoming bitstream BS generated using a particular coding standard, such as HEVC (High Efficiency Video Coding) or VP9. However, this is for illustrative purposes only, and is not meant to be a limitation of the present invention. Any video decoder using the proposed video decoder structure falls within the scope of the present invention.

The entropy decoding circuit 102 is arranged to apply entropy decoding to the incoming bitstream BS for generating intra mode information INFᵢₙₜᵣₐ inter mode information INFᵢₙₜₑᵣ (e.g., motion vector (MV) information), and residues. The residues are transmitted to the reconstruction circuit 110 through being inverse scanned (which is performed at the inverse scan circuit 104), inverse quantized (which is performed at the inverse quantization circuit 106), and inverse transformed (which is performed at the inverse transform circuit 108). When a block (e.g., a coding unit) in an original picture is encoded using an intra prediction mode, the intra prediction circuit 116 is enabled to generate predicted pixels/samples to the reconstruction circuit 110. When the block in the original picture is encoded using an inter prediction mode, the motion compensation circuit 118 is enabled to generate predicted pixels/samples to the reconstruction circuit 110. The reconstruction circuit 110 is arranged to combine a residue output of the inverse transform circuit 108 and a predicted pixel output of one of intra prediction circuit 116 and motion compensation circuit 118 to thereby generate reconstructed pixels/samples of each block of a picture (i.e., a reconstructed/decoded picture). The deblocking filter 112 is arranged to apply deblocking filtering to the reconstructed pixels/samples generated from the reconstruction circuit 110, and then generate a deblocked picture (which is composed of filtered pixels/samples) as a reference picture. The reference picture is stored into the reference picture buffer 114, and may be referenced by the motion compensation circuit 118 to generate predicted pixels/samples of other blocks.

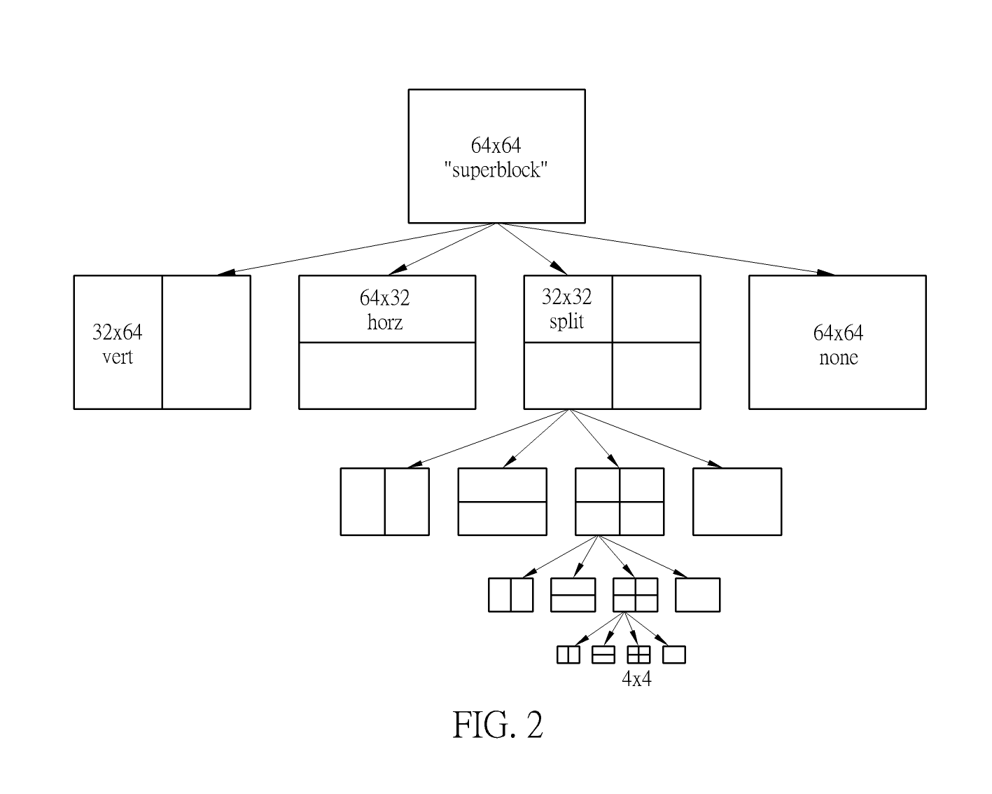

In this embodiment, the incoming bitstream BS may have coding units with various coding unit sizes. In an advanced video coding standard (e.g., HEVC or VP9), the coding unit is not necessarily limited to a 16×16 block size. Taking the VP9 coding standard for example, one picture may be divided into 64×64-sized blocks that are called superblocks. Superblocks of the picture are processed in raster order: left to right, top to bottom. In addition, VP9 supports quad-tree based encoding. Hence, recursive partitioning may be employed to split each superblock into one or more partitions (e.g., smaller-sized blocks) for further processing. FIG. 2 is a diagram illustrating recursive partitioning of one superblock into various sizes of mode information (MI) units. For example, one superblock with the block size of 64×64 may be split into one or more coding units (or called MI units in VP9), where the partitions supported by VP9 coding standard may include square partitions, such as a 64×64-sized block, a 32×32-sized block, a 16×16-sized block, a 8×8-sized block, a 4×4-sized block, and may further include non-square partitions, such as a 64×32-sized block, a 32×64-sized block, 32×16-sized block, a 16×32-sized block, . . . , a 4×8-sized block, a 8×4-sized block. Hence, the coding unit (MI unit) sizes may include 64×64, 32×32, 16×16, 8×8, 64×32, 32×64, 32×16, 16×32, . . . , 8×8, 4×8, 8×4, 4×4. That is, the variable coding unit size in VP9 may range from 4×4 to 64×64.

Since the advanced video coding standard allows various coding unit sizes, a pipeline imbalance issue resulting from the variable coding unit size may occur when the above-mentioned processing circuits in the video processing apparatus 100 are configured to operate in a pipeline fashion. Hence, in addition to the above-mentioned processing circuits, the proposed video processing apparatus 100 may further include at least one control circuit to deal with the pipeline imbalance issue for decoding the bitstream BS in an efficient and cost-effective manner. As shown in FIG. 1, the video processing apparatus 100 further has a plurality of control circuits 122, 124, 126, 128, and 130, where the control circuit 122 is coupled between the entropy decoding circuit 102 and the intra prediction circuit 116, the control circuit 124 is coupled between the entropy decoding circuit 102 and the inverse scan circuit 104, the control circuit 126 is coupled between the inverse transform circuit 108 and the reconstruction circuit 110, the control circuit 128 is coupled between the reconstruction circuit 110 and the deblocking filter 112, and the control circuit 130 is coupled between the entropy decoding circuit 102 and the motion compensation circuit 118. Each of the control circuits 122, 124, 126, 128, and 130 may be configured to support at least one of a plurality of pre-defined functions, including a coding unit splitting function, a coding unit merging function, and a first-in first-out (FIFO) buffering function. Further details of the proposed control circuit are described as below.

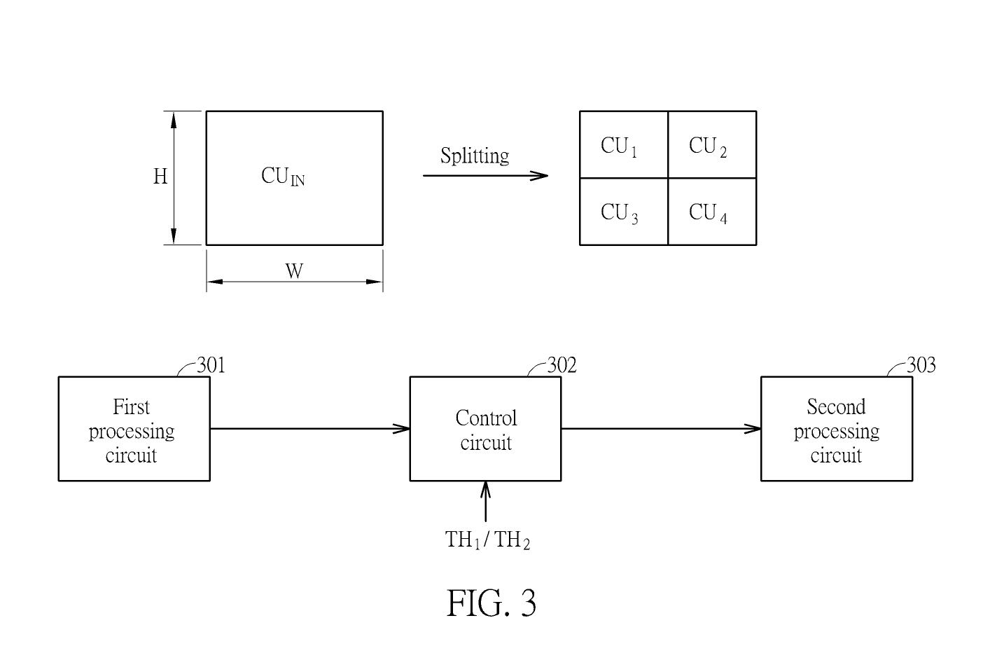

FIG. 3 is a diagram illustrating a control circuit with a coding unit splitting function according to an embodiment of the present invention. In this embodiment, the control circuit 302 is coupled between a first processing circuit 301 and a second processing circuit 303. The first processing circuit 301 is configured to perform a first processing operation (e.g., entropy decoding or other decoding function) to generate a processing result of an input coding unit (e.g., CU_{IN}) to the control circuit 302. The control circuit 302 is configured to generate at least one output coding unit (e.g., CU₁-CU₄) according to the input coding unit (e.g., CU_{IN}) generated from the first processing operation. The second processing circuit 303 is configured to perform a second processing operation (e.g., intra prediction or other decoding function) upon the at least one output coding unit provided from the control circuit 302, where the second processing operation is different from the first processing operation. In this embodiment, the control circuit 302 is configured to check a size of an input coding unit (e.g., CU_{IN}) to selectively split the input coding unit (e.g., CU_{IN}) into a plurality of output coding units (e.g., CU₁, CU₂, CU₃ and CU₄). For example, the control circuit 302 may compare a width W of an input coding unit (e.g., CU_{IN}) with a first threshold (i.e., a coding unit width threshold) TH₁, and/or may compare a height H of the input coding unit (e.g., CU_{IN}) with a second threshold (i.e., a coding unit height threshold) TH₂.

In a first exemplary design, the control circuit 302 may compare the width W of the input coding unit (e.g., CU_{IN}) with the first threshold TH₁ to generate a first comparing result, and may selectively split the input coding unit (e.g., CU_{IN}) into multiple output coding units (e.g., CU₁-CU₄) according to the first comparing result, where the size of each output coding unit generated due to coding unit splitting is smaller than the size of the input coding unit.

In a second exemplary design, the control circuit 302 may compare the height H of the input coding unit (e.g., CU_{IN}) with the second threshold TH₂ to generate a second comparing result, and may selectively split the input coding unit (e.g., CU_{IN}) into multiple output coding units (e.g., CU₁-CU₄) according to the second comparing result, where the size of each output coding unit generated due to coding unit splitting is smaller than the size of the input coding unit.

In a third exemplary design, the control circuit 302 may compare the width W of the input coding unit (e.g., CU_{IN}) with the first threshold TH₁ to generate a first comparing result and compare the height H of the input coding unit (e.g., CU_{IN}) with the second threshold TH₂ to generate a second comparing result, and may selectively split the input coding unit (e.g., CU_{IN}) into multiple output coding units (e.g., CU₁-CU₄) according to the first comparing result and the second comparing result, where the size of each output coding unit generated due to coding unit splitting is smaller than the size of the input coding unit.

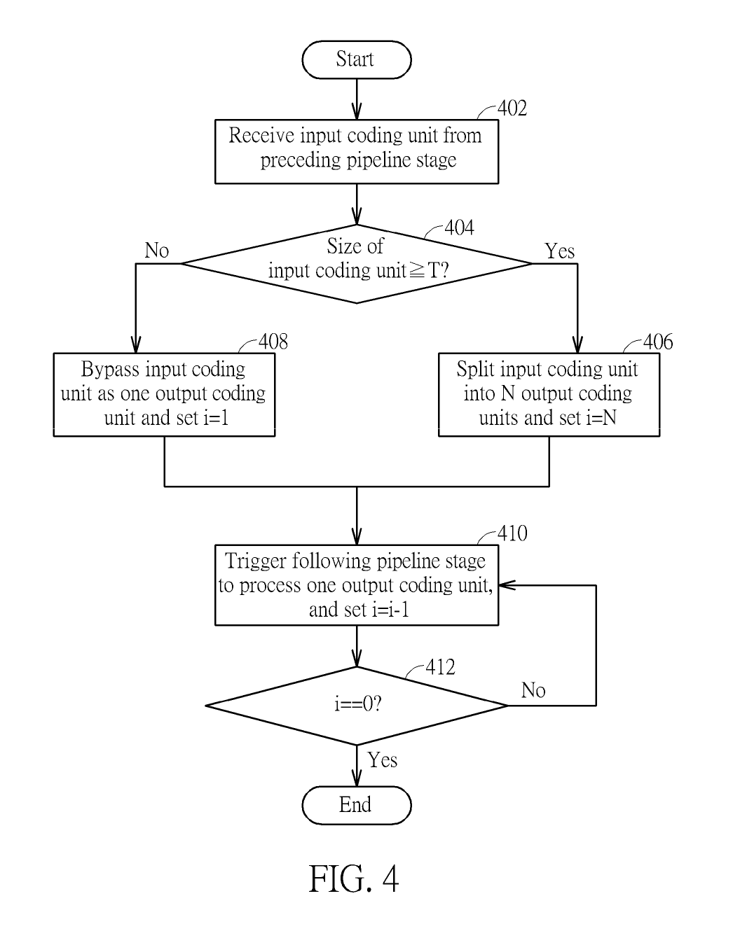

FIG. 4 is a flowchart illustrating a coding unit splitting method according to an embodiment of the present invention. Provided that the result is substantially the same, the steps are not required to be executed in the exact order shown in FIG. 4. The coding unit splitting method may be performed by the control circuit 302 shown in FIG. 3, and may be briefly summarized as below.

Step 402: Receive an input coding unit (e.g., CU_{IN}) from a preceding pipeline stage (e.g., first processing circuit 301).

Step 404: Check if the size of the input coding unit is equal to or larger than a coding unit size threshold T. For example, the coding unit size threshold T may include one or both of the first threshold TH₁ and the second threshold TH₂. If the size of the input coding unit is equal to or larger than the coding unit size threshold T, the flow proceeds with step 406; otherwise, the flow proceeds with step 408.

Step 406: Split the input coding unit into N partitions acting as output coding units to be processed by a following pipeline stage (e.g., second processing circuit 303), and set i=N. Go to step 410.

Step 408: Bypass the input coding unit as an output coding unit to be processed by the following pipeline stage (e.g., second processing circuit 303), and set i=1.

Step 410: Trigger the following pipeline stage (e.g., second processing circuit 303) to process one output coding unit at a time, and set i=i−1.

Step 412: Check if i==0. If yes, the control flow associated with the input coding unit is done; otherwise, the flow proceeds with step 410 to process another output coding unit.

When the size of the input coding unit is equal to or larger than the coding unit size threshold T, a coding unit splitting function is enabled to split the input coding unit with a larger size into a plurality of output coding units each having a smaller size (steps 402, 404 and 406). In this way, the following pipeline stage is triggered to process the smaller-sized output coding units one by one (steps 410 and 412). Hence, a cost-effective video decoder can be achieved due to relaxed pipeline buffer requirement. Further, the number of waiting cycles required by the following pipeline stage can be effectively reduced.

When the size of the input coding unit is smaller than the coding unit size threshold T, a coding unit splitting function is not enabled, such that the input coding unit generated from the preceding pipeline stage may be directly fed into the following pipeline stage (steps 402, 404, and 408). Hence, the following pipeline stage is triggered to process one output coding unit that is the same as the input coding unit (steps 410 and 412).

It should be noted that the coding unit size threshold T (which may include one or both of the first threshold (coding unit width threshold) TH₁ and the second threshold (coding unit height threshold) TH₂) can be adjusted, depending upon the actual design considerations. In addition, the number of split partitions (i.e., the value of N) can be decided according to the size of the input coding unit. For example, the coding unit size threshold T may be set by {TH₁=64 and TH₂=64}, and the value of N may be set by 4. Hence, one 64×64 input coding unit may be split into four 32×32 output coding units that will be processed by the second processing circuit 303 one by one. For another example, the coding unit size threshold T may be set by {TH₁=64 or TH₂=64}. The value of N may be adaptively set in response to the size of the input coding unit. If the size of the input coding unit is 64×64, N=4. Hence, one 64×64 input coding unit may be split into four 32×32 output coding units that will be processed by the second processing circuit 303 one by one. If the size of the input coding unit is 32×64, N=2. Hence, one 32×64 input coding unit may be split into two 32×32 output coding units that will be processed by the second processing circuit 303 one by one. If the size of the input coding unit is 64×32, N=2. Hence, one 64×32 input coding unit may be split into two 32×32 output coding units that will be processed by the second processing circuit 303 one by one. Moreover, the sizes of the split partitions can be adjusted, depending upon actual design consideration. For example, the output coding units generated from the coding unit splitting function may include square partitions only. For another example, the output coding units generated from the coding unit splitting function may include non-square partitions only. For yet another example, the output coding units generated from the coding unit splitting function may include square partition(s) and non-square partition(s).

However, the above are for illustrative purposes only, and are not meant to be a limitation of the present invention. Any smaller-sized output coding unit generated to a following pipeline stage from splitting a larger-sized input coding unit generated from a preceding pipeline stage falls within the scope of the present invention.

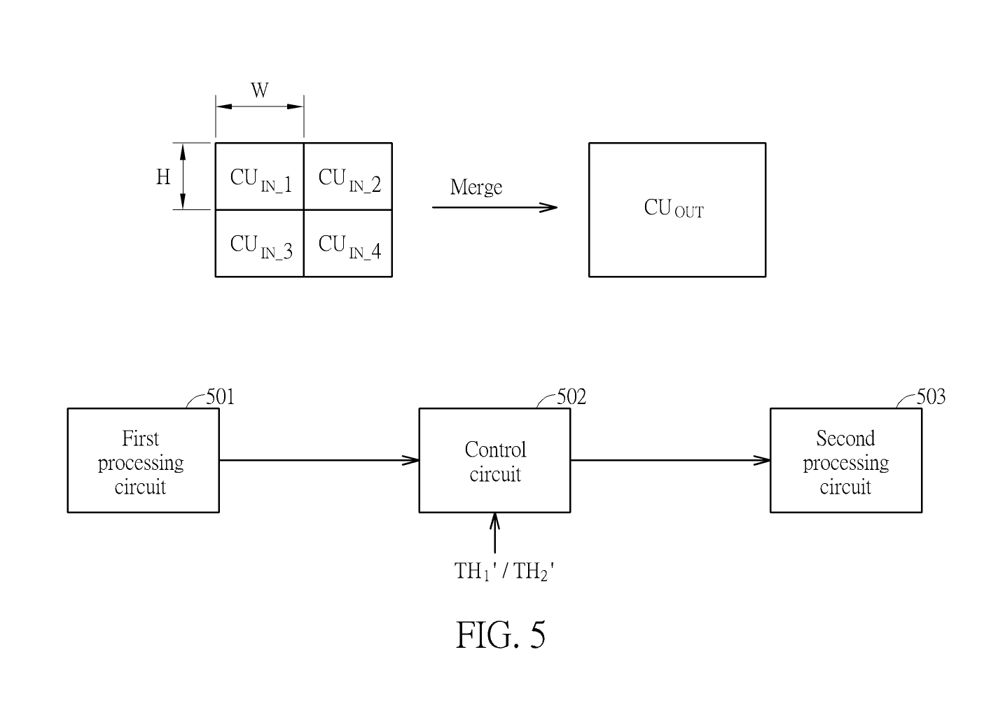

FIG. 5 is a diagram illustrating a control circuit with a coding unit merging function according to an embodiment of the present invention. In this embodiment, the control circuit 502 is coupled between a first processing circuit 501 and a second processing circuit 503. The first processing circuit 501 is configured to perform a first processing operation (e.g., reconstruction or other decoding function) to generate processing results of a plurality of input coding units (e.g., CU_{IN}_{_{—}}1-CU_{IN}_{_{—}}4) to the control circuit 502. The control circuit 502 is configured to generate at least one output coding unit (e.g., CU_{OUT}) according to the input coding units (e.g., CU_{IN}_{_{—}}1-CU_{IN}_{_{—}}4) generated from the first processing operation. The second processing circuit 503 is configured to perform a second processing operation (e.g., deblocking or other decoding function) upon the at least one output coding unit (e.g., CU_{OUT}) provided from the control circuit 502, where the second processing operation is different from the first processing operation. In this embodiment, the control circuit 502 is configured to check sizes of the input coding units (e.g., CU_{IN}_{_{—}}1-CU_{IN}_{_{—}}4) to selectively merge the input coding unit (e.g., CU_{IN}_{_{—}}1-CU_{IN}_{_{—}}4) into a single output coding unit (e.g., CU_{OUT}). For example, the control circuit 502 may compare widths W of the input coding units (e.g., CU_{IN}_{_{—}}1-CU_{IN}_{_{—}}4) with a first threshold (i.e., a coding unit width threshold) TH₁′, and/or may compare heights H of the input coding units (e.g., CU_{IN}_{_{—}}1-CU_{IN}_{_{—}}4) with a second threshold (i.e., a coding unit height threshold) TH₂′.

In a first exemplary design, the control circuit 502 may compare the widths of the input coding units (e.g., CU_{IN}_{_{—}}1-CU_{IN}_{_{—}}4) with the first threshold TH₁′ to generate a first comparing result, and may selectively merge the input coding units (e.g., CU_{IN}_{_{—}}1-CU_{IN}_{_{—}}4) into a single output coding unit (e.g., CU_{OUT}) according to the first comparing result, where the size of each input coding unit is smaller than the size of the output coding unit generated due to coding unit merging.

In a second exemplary design, the control circuit 502 may compare the heights of the input coding units (e.g., CU_{IN}_{_{—}}1-CU_{IN}_{_{—}}4) with the second threshold TH₂′ to generate a second comparing result, and may selectively merge the input coding units (e.g., CU_{IN}_{_{—}}1-CU_{IN}_{_{—}}4) into a single output coding unit (e.g., CU_{OUT}) according to the second comparing result, where the size of each input coding unit is smaller than the size of the output coding unit generated due to coding unit merging.

In a third exemplary design, the control circuit 502 may compare the widths of the input coding units (e.g., CU_{IN}_{_{—}}1-CU_{IN}_{_{—}}4) with the first threshold TH₁′ to generate a first comparing result and compare the heights of the input coding units (e.g., CU_{IN}_{_{—}}1-CU_{IN}_{_{—}}4) with the second threshold TH₂′ to generate a second comparing result, and may selectively merge the input coding units (e.g., CU_{IN}_{_{—}}1-CU_{IN}_{_{—}}4) into a single output coding unit (e.g., CU_{OUT}) according to the first comparing result and the second comparing result, where the size of each input coding unit is smaller than the size of the output coding unit generated due to coding unit merging.

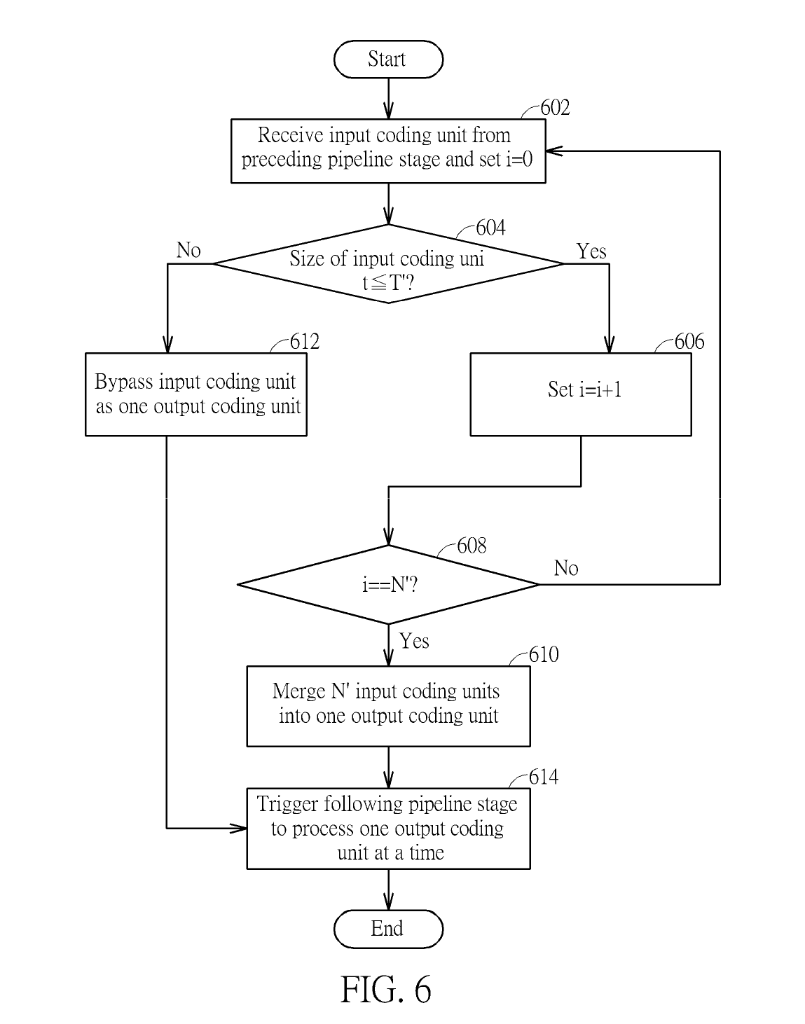

FIG. 6 is a flowchart illustrating a coding unit merging method according to an embodiment of the present invention. Provided that the result is substantially the same, the steps are not required to be executed in the exact order shown in FIG. 6. The coding unit merging method may be performed by the control circuit 502 shown in FIG. 5, and may be briefly summarized as below.

Step 602: Receive an input coding unit from a preceding pipeline stage (e.g., first processing circuit 501), and set i=0.

Step 604: Check if the size of the input coding unit is equal to or smaller than a coding unit size threshold T′. For example, the coding unit size threshold T′ may include one or both of the first threshold TH₁′ and the second threshold TH₂′. If the size of the input coding unit is not larger than the coding unit size threshold T, the flow proceeds with step 606; otherwise, the flow proceeds with step 612.

Step 606: Set i=i+1.

Step 608: Check if i==N′. If yes, go to step 610; otherwise, go to step 602 to receive another input coding unit from the preceding pipeline stage.

Step 610: Merge the N′ input coding units, each having a size not larger than the coding unit size threshold T′, into a single output coding unit to be processed by a following pipeline stage (e.g., second processing circuit 303). Go to step 614.

Step 612: Bypass the input coding unit as one output coding unit to be processed by the following pipeline stage (e.g., second processing circuit 303).

Step 614: Trigger the following pipeline stage (e.g., second processing circuit 303) to process one output coding unit at a time.

When the size of an input coding unit is not larger than the coding unit size threshold T′, a coding unit merging function is enabled to make the input coding unit with a smaller size become one part of an output coding unit with a larger size (steps 602, 604, 606 and 608). After the larger-sized output coding unit is finally derived from merging more than one smaller-sized input coding unit, the following pipeline stage is triggered to process the larger-sized output coding unit at a time (steps 610 and 614). Hence, due to less handshaking needed by decoding of a larger-sized output coding unit, the decoding efficiency of smaller-sized input coding units can be improved by merging the smaller-sized input coding units into one larger-sized output coding unit. When the size of the input coding unit is larger than the coding unit size threshold T′, a coding unit merging function is not enabled for the input coding unit, such that the input coding unit generated from the preceding pipeline stage may be directly fed into the following pipeline stage (steps 602, 604, and 612). Hence, the following pipeline stage is triggered to process one output coding unit that is the same as the input coding unit (step 614).

It should be noted that the coding unit size threshold T′ (which may include one or both of the first threshold (coding unit width threshold) TH₁′ and the second threshold (coding unit height threshold) TH₂′) can be adjusted, depending upon the actual design considerations. In addition, the number of merged partitions (i.e., the value of N′) can be decided according to the size of the input coding unit. For example, the coding unit size threshold T′ may be set by {TH₁′=8 and TH₂′=8}, and the value of N′ may be set by 4. Hence, four 8×8 input coding units may be merged into one 16×16 output coding unit that will be processed by the second processing circuit 503 at a time. For another example, the coding unit size threshold T′ may be set by {TH₁′=8 or TH₂′=8}. The value of N′ may be set in response to the size of the input coding unit. If the size of the input coding unit is 8×8, N′=4. Hence, four 8×8 input coding units may be merged into one 16×16 output coding unit that will be processed by the second processing circuit 503 at a time. If the size of the input coding unit is 16×8, N′=2. Hence, two 16×8 input coding units may be merged into one 16×16 output coding unit that will be processed by the second processing circuit 503 at a time. If the size of the input coding unit is 8×16, N′=2. Hence, two 8×16 input coding units may be merged into one 16×16 output coding unit that will be processed by the second processing circuit 503 at a time. Moreover, the sizes of the partitions to be merged can be adjusted, depending upon actual design consideration. For example, the input coding units processed by the coding unit merging function may include square partitions only. For another example, the input coding units processed by the coding unit merging function may include non-square partitions only. For yet another example, the input coding units processed by the coding unit merging function may include square partition(s) and non-square partition(s).

However, the above are for illustrative purposes only, and are not meant to be a limitation of the present invention. Any larger-sized output coding unit generated to a following pipeline stage from merging smaller-sized input coding units generated from a preceding pipeline stage falls within the scope of the present invention.

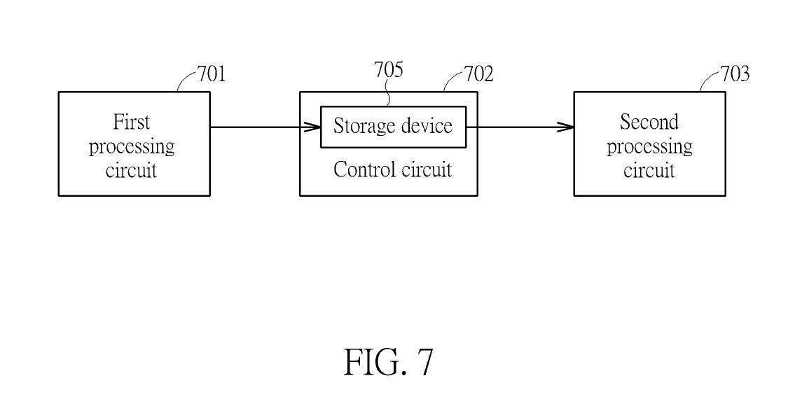

FIG. 7 is a diagram illustrating a control circuit with a FIFO buffering function according to an embodiment of the present invention. In this embodiment, the control circuit 702 is coupled between a first processing circuit 701 and a second processing circuit 703. The first processing circuit 701 is configured to perform a first processing operation to generate processing results of a plurality of input coding units to the control circuit 702. The control circuit 702 has a storage device 705 serving as a FIFO buffer for sequentially buffering input coding units generated from the first processing circuit 701 and sequentially outputting the buffered input coding units as output coding units. By way of example, but not limitation, the storage device 705 may be implemented using a single storage unit, or may be implemented using multiple storage units. Further, the storage device 705 may be an internal storage device, an external storage device, or a hybrid storage device composed of an internal storage device and an external storage device. To put it simply, the present invention has no limitations on the actual implementation of the storage device 705. The second processing circuit 703 is configured to perform a second processing operation upon the output coding units provided from the control circuit 702 (particularly, the storage device 705), where the second processing operation is different from the first processing operation.

In a case where a larger-sized coding unit is generated from a preceding pipeline stage (i.e., first processing circuit 701) to a following pipeline stage (i.e., second processing circuit 703) and a smaller-sized coding unit is fed into the preceding pipeline stage (i.e., first processing circuit 701), the preceding pipeline stage (i.e., first processing circuit 701) will finish the decoding of the smaller-sized coding unit before the following pipeline stage finishes the decoding of the larger-sized coding unit. The storage device 705 in the control circuit 702 may be used to buffer the decoding result of the smaller-sized coding unit and associated commands, thereby allowing the preceding pipeline stage (i.e., first processing circuit 701) to start processing a next coding unit before the following pipeline stage starts processing the smaller-sized coding unit. When the following pipeline stage finishes the decoding of the larger-sized coding unit, the control circuit 702 may output the buffered decoding result of the smaller-sized coding unit and associated commands to the following pipeline stage. In this way, a bitstream with various coding unit sizes can be efficiently decoded. Specifically, the pipeline imbalance can be avoided/mitigated by using the control circuit 702 with the FIFO buffering function. For better understanding of the benefits offered by the FIFO buffering function of the control circuit 702, an example of inserting one control circuit with the FIFO buffering function between two pipeline stages is given as below.

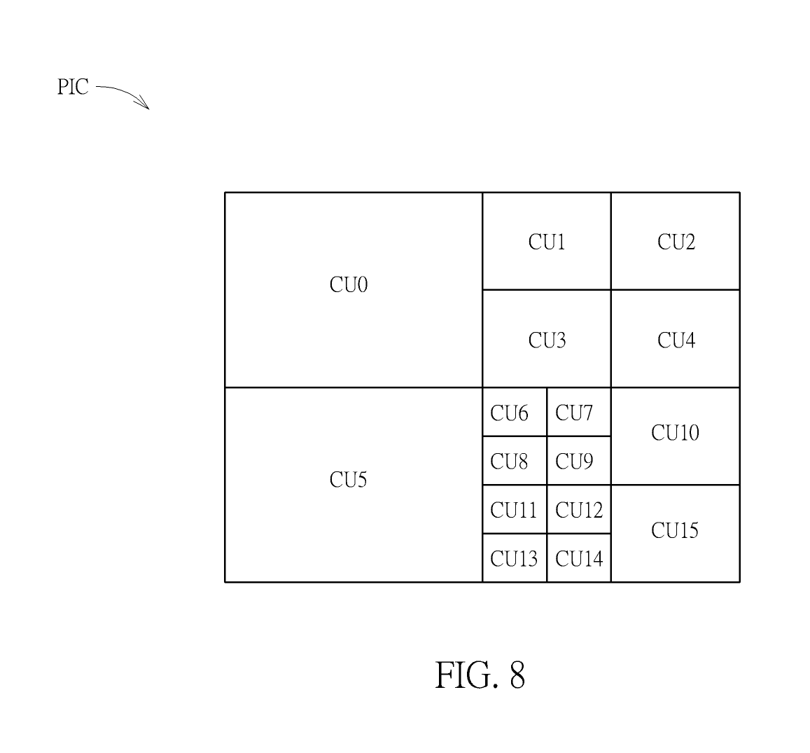

FIG. 8 is a diagram illustrating a picture partitioned into coding units with various coding unit sizes according to an embodiment of the present invention. In this example, the picture may include a plurality of coding units CU0-CU15. Each of the coding units CU0 and CU5 has a first coding unit size, each of the coding units CU1-CU4, CU10, and CU15 has a second coding unit size, and each of the coding units CU6-CU9 and CU11-CU14 has a third coding unit size. The first coding unit size (e.g., 64×64) is 4 times as large as the second coding unit size (e.g., 32×32), and the second coding unit size (e.g., 32×32) is 4 times as large as the third coding unit size (e.g., 16×16).

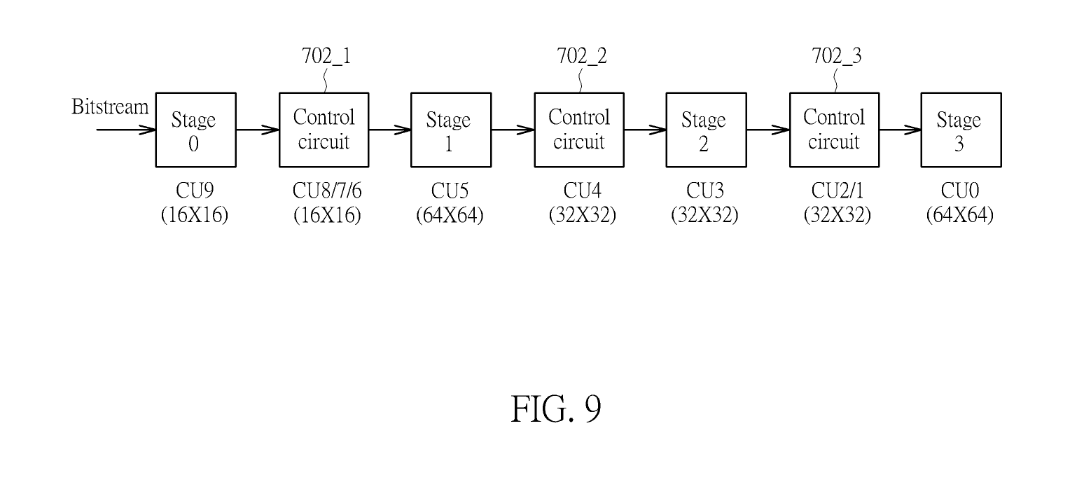

Please refer to FIG. 8 in conjunction with FIG. 9. FIG. 9 is a diagram illustrating a video processing apparatus having a plurality of pipeline stages and a plurality of control circuits according to an embodiment of the present invention. In this embodiment, each of the control circuits 702_1, 702_2 and 702_3 may be implemented using the control circuit 702 shown in FIG. 7. Hence, each of the control circuits 702_1, 702_2 and 702_3 may support the FIFO buffering function. As shown in the figure, the control circuit 702_1 is coupled between the pipeline stage 0 (e.g., entropy decoding) and the pipeline stage 1 (e.g., motion compensation/intra prediction), the control circuit 702_2 is coupled between the pipeline stage 1 (e.g., motion compensation/intra prediction) and the pipeline stage 2 (e.g., reconstruction), and the control circuit 702_3 is coupled to the pipeline stage 2 (e.g., reconstruction) and the pipeline stage 3 (e.g., in-loop deblocking). The coding units CU0-CU15 included in the bitstream will be decoded in order. For example, each of the coding units CU0-CU15 will be processed by pipeline stage 0, pipeline stage 1, pipeline stage 2 and pipeline stage 3 in order. Since the coding units CU0-CU15 do not have the same coding unit size, each of the control circuits 702_1, 702_2 and 702_3 can buffer data of coding units and associated commands transmitted between two pipeline stages.

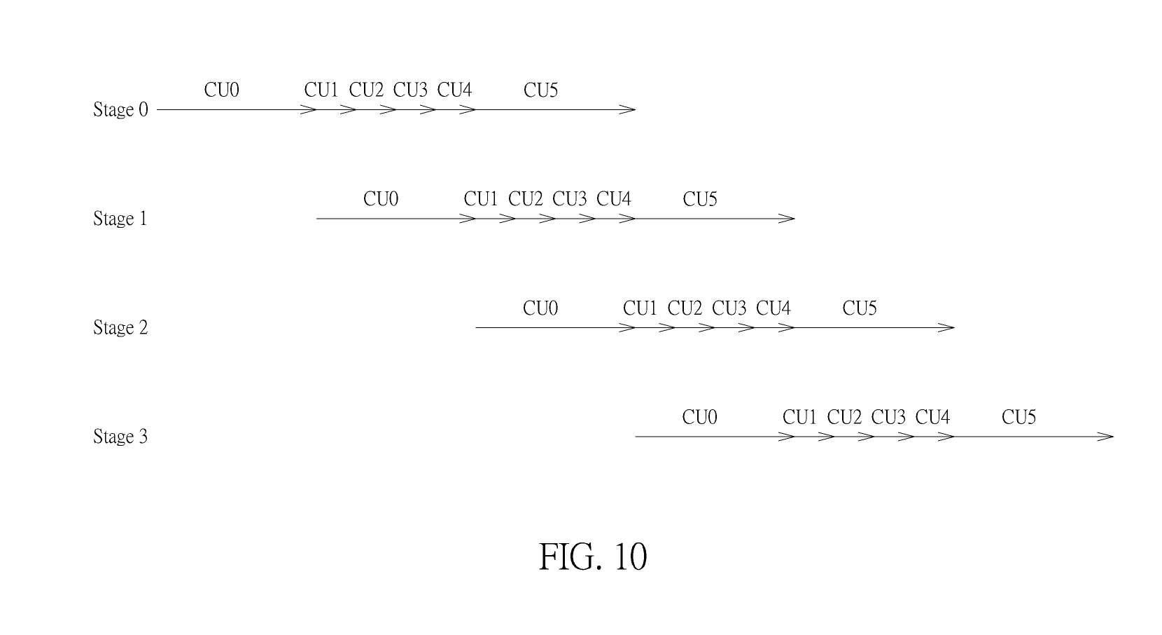

As shown in FIG. 9, while the pipeline stage 3 is processing the coding unit CU0, the pipeline stage 2 may be used to process the coding unit CU3, the pipeline stage 1 may be used to process the coding unit CU5, and the pipeline stage 0 may be used to process the coding unit CU9, where data of the coding units CU6, CU7, CU8 processed and output by the pipeline stage 0 is temporarily stored in a storage device (e.g., a FIFO buffer) managed by the control circuit 702_1, data of the coding unit CU4 processed and output by the pipeline stage 1 is temporarily stored in a storage device (e.g., a FIFO buffer) managed by the control circuit 702_2, and data of the coding units CU1 and CU2 processed and output by the pipeline stage 2 is temporarily stored in a storage device (e.g., a FIFO buffer) managed by the control circuit 702_3. FIG. 10 is a diagram illustrating the pipeline processing of coding units according to an embodiment of the present invention. Due to the use of the control circuits 702_1, 702_2 and 702_3 with the FIFO buffering function, none of pipeline stage 0, pipeline stage 1, pipeline stage 2 and pipeline stage 3 suffers from bubbles (i.e., waiting cycles) caused by various coding unit sizes.

In the example shown in FIG. 3, the control circuit 302 is configured to support a coding unit splitting function. In the example shown in FIG. 5, the control circuit 502 is configured to support a coding unit merging function. In the example shown in FIG. 7, the control circuit 702 is configured to support a FIFO buffering function. However, these are for illustrative purposes only, and are not meant to be limitations of the present invention. Alternative, a control circuit may be configured to support at least two of the coding unit splitting function, the coding unit merging function, and the FIFO buffering function.

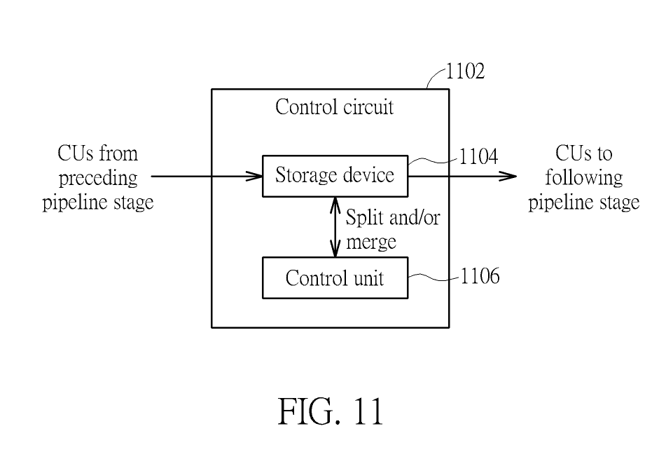

FIG. 11 is a diagram illustrating a control circuit that supports at least two of the coding unit splitting function, the coding unit merging function and the FIFO buffering function according to an embodiment of the present invention. In this embodiment, the control circuit 1102 has a storage device 1104 and a control unit 1106. The storage device 1104 serves as a FIFO buffer used for buffering input coding units and associated commands generated from the preceding pipeline stage. Byway of example, but not limitation, the storage device 1104 may be implemented using a single storage unit, or may be implemented using multiple storage units. Further, the storage device 1104 may be an internal storage device, an external storage device, or a hybrid storage device composed of an internal storage device and an external storage device. To put it simply, the present invention has no limitations on the actual implementation of the storage device 1104. The control unit 1106 may be configured to apply the coding unit splitting function to at least a portion (i.e., part or all) of the coding units buffered in the storage device 1104, may be configured to apply the coding unit merging function to at least a portion (i.e., part or all) of the coding units buffered in the storage device 1104, and/or may be configured to control the storage device 1104 to offer the FIFO buffering function.

Byway of example, but not limitation, the control circuit 122 shown in FIG. 1 may be implemented using the control circuit 1102 configured to support the coding unit splitting function and the FIFO buffering function; the control circuit 124 shown in FIG. 1 may be implemented using the control circuit 1102 configured to support the FIFO buffering function; the control circuit 126 shown in FIG. 1 may be implemented using the control circuit 1102 configured to support the FIFO buffering function; the control circuit 128 shown in FIG. 1 may be implemented using the control circuit 1102 configured to support the coding unit splitting function, the coding unit merging function and the FIFO buffering function; and the control circuit 130 shown in FIG. 1 may be implemented using the control circuit 1102 configured to support the coding unit merging function and the FIFO buffering function. However, these are for illustrative purposes only, and are not meant to be limitations of the present invention. Any video processing apparatus (e.g., video decoder) that employs one or more of the proposed coding unit splitting function, coding unit merging function and FIFO buffering function falls within the scope of the present invention.

Those skilled in the art will readily observe that numerous modifications and alterations of the device and method may be made while retaining the teachings of the invention. Accordingly, the above disclosure should be construed as limited only by the metes and bounds of the appended claims.

What is claimed is:

1. A video processing apparatus comprising:
a first processing circuit, configured to perform a first processing operation;
a second processing circuit, configured to perform a second processing operation different from the first processing operation; and
a control circuit, configured to generate at least one output coding unit to the second processing circuit according to an input coding unit generated from the first processing circuit, wherein the control circuit checks a size of the input coding unit to selectively split the input coding unit into a plurality of output coding units.

2. The video processing apparatus of claim 1, wherein the control circuit compares a width of the input coding unit with a first threshold to generate a first comparing result, and selectively splits the input coding unit into the output coding units according to at least the first comparing result.

3. The video processing apparatus of claim 2, wherein the control circuit compares a height of the input coding unit with a second threshold to generate a second comparing result, and selectively splits the input coding unit into the output coding units according to the first comparing result and the second comparing result.

4. The video processing apparatus of claim 1, wherein the control circuit compares a height of the input coding unit with a threshold to generate a comparing result, and selectively splits the input coding unit into the output coding units according to the comparing result.

5. The video processing apparatus of claim 1, wherein the first processing circuit is an entropy processing circuit or a reconstruction circuit.

6. The video processing apparatus of claim 1, wherein the second processing circuit is an intra prediction circuit or a deblocking filter.

7. The video processing apparatus of claim 1, wherein the control circuit comprises a storage device configured to buffer data of coding units and associated commands transmitted between the first processing circuit and the second processing circuit.

8. A video processing apparatus comprising:
a first processing circuit, configured to perform a first processing operation;
a second processing circuit, configured to perform a second processing operation different from the first processing operation; and
a control circuit, configured to generate at least one output coding unit to the second processing circuit according to a plurality of input coding units generated from the first processing circuit, wherein the control circuit checks sizes of the input coding units to selectively merge the input coding units into a single output coding unit.

9. The video processing apparatus of claim 8, wherein the control circuit compares widths of the input coding units with a first threshold to generate a first comparing result, and selectively merges the input coding units into the single output coding unit according to at least the first comparing result.

10. The video processing apparatus of claim 9, wherein the control circuit compares heights of the input coding units with a second threshold to generate a second comparing result, and selectively merges the input coding units into the single output coding unit according to the first comparing result and the second comparing result.

11. The video processing apparatus of claim 8, wherein the control circuit compares heights of the input coding unit with a threshold to generate a comparing result, and selectively merges the input coding units into the single output coding unit according to the comparing result.

12. The video processing apparatus of claim 8, wherein the first processing circuit is a reconstruction circuit or an entropy decoding circuit.

13. The video processing apparatus of claim 8, wherein the second processing circuit is a deblocking filter or a motion compensation circuit.

14. The video processing apparatus of claim 8, wherein the control circuit comprises a storage device configured to buffer data of coding units and associated commands transmitted between the first processing circuit and the second processing circuit.

15. A video processing method comprising:
performing a first processing operation to generate an input coding unit;
generate at least one output coding unit according to the input coding unit generated from the first processing operation, comprising:
checking a size of the input coding unit to selectively split the input coding unit into a plurality of output coding units; and
performing a second processing operation upon the at least one output coding unit, wherein the second processing operation is different from the first processing operation.

16. A video processing method comprising:
performing a first processing operation to generate a plurality of input coding units;
generating at least one output coding unit according to the input coding units generated from the first processing operation, comprising:
checking sizes of the input coding units to selectively merge the input coding units into a single output coding unit; and
performing a second processing operation upon the at least one output coding unit, wherein the second processing operation is different from the first processing operation.

17. A video processing apparatus comprising:
a plurality of processing circuits, comprising an entropy decoding circuit, an inverse scan circuit, an inverse quantization circuit, an inverse transform circuit, a reconstruction circuit, an in-loop filter, a reference picture buffer, an intra prediction circuit, and a motion compensation circuit; and
a control circuit, coupled between a first processing circuit and a second processing circuit of the processing circuits, wherein the control circuit is configured to generate at least one output coding unit to the second processing circuit according to at least one input coding unit generated from the first processing circuit, wherein a size of each of the at least one input coding unit is different from a size of each of the at least one output coding unit.

18. The video processing apparatus of claim 17, wherein the control circuit splits a single input coding unit into a plurality of output coding units.

19. The video processing apparatus of claim 17, wherein the control circuit merges a plurality of input coding units into a single output coding unit.

20. The video processing apparatus of claim 17, wherein the first processing circuit is one of the reconstruction circuit and the entropy decoding circuit; or the second processing circuit is one of the in-loop filter and the motion compensation circuit.
